(19) United States
(12) Patent Application Publication
(10) Pub. No.: US 2024/0265464 A1
(43) Pub. Date: Aug. 8, 2024

(54) SYSTEM AND METHOD FOR PROCESSING HEALTHCARE TRANSACTIONS

(71) Applicant: Thatch Health, Inc., San Francisco, CA (US)

(72) Inventors: Christian ELLIS, Austin, TX (US); Adam STEVENSON, San Diego, CA (US); Karun KANNAN, Westford, MA (US); Kristina SHIA, Irvine, CA (US); Charles Sebastiaan DE WATER, Montreal (CA); Daniel HANSON, San Francisco, CA (US); Olivier BELLONE, Bellevue, WA (US); Shivam SARODIA, San Mateo, CA (US)

(73) Assignee: Thatch Health, Inc., San Francisco, CA (US)

(21) Appl. No.: 18/434,776

(22) Filed: Feb. 6, 2024

Related U.S. Application Data
(60) Provisional application No. 63/443,535, filed on Feb. 6, 2023.
(60) Provisional application No. 63/468,503, filed on May 23, 2023.

(51) Int. Cl. G06Q 40/08; G06Q 20/34; G06Q 20/40

(52) U.S. Cl. CPC G06Q 40/08; G06Q 20/34; G06Q 20/401

(57) ABSTRACT

An embodiment of the present disclosure is a system and method of processing healthcare payments through an individual coverage health reimbursement arrangement. The system and method may include receiving a transaction related to a qualified medical expense via a payment card, funding the transaction from a funding account to a member checking account associated with the payment card, transferring the amount from the member checking account to a seller associated with the qualified medical expense and recording an amount of the transaction into an invoice database. Each recorded amount corresponds to a generated invoice. The system and method further includes combining the generated invoices in the invoice database to calculate an aggregated employer invoice amount and debiting the aggregated employer invoice amount from an employer operating account. Thereafter, the system and method includes paying the aggregated employer invoice amount into a system batch account. Finally, the system and method includes initiating a transfer from the system batch account to the funding account. The system and method may further include processing healthcare payments through a health savings account.

### CROSS-REFERENCE TO RELATED APPLICATIONS

The present application claims priority to and the benefit of U.S. Provisional Patent Application No. 63/443,535, filed on Feb. 6, 2023, and U.S. Provisional Patent Application No. 63/468,503, filed on May 23, 2023, the contents of which are incorporated by reference herein in their entirety.

### BACKGROUND

The present disclosure relates to systems and related methods for processing healthcare transactions over a communications network. Specifically, the present disclosure relates to systems and related methods for processing transactions in a health savings account and an individual coverage health reimbursement arrangement.

The present disclosure relates generally to a system and method that establishes and utilizes health savings accounts for payment of qualified medical expenses in an efficient manner. It is foreseeable that this disclosure may be tailored such that it allows individuals and employers to customize different aspects of the system and method for processing transactions in a health savings account based on user need.

The subject matter described herein relates to maximizing cost savings and efficiently using health savings accounts by efficiently processing medical transactions. In general, health savings accounts (“HSA”) are valuable member-owned accounts that allow members to save pre-tax dollars for future qualified medical expenses. Conventionally, members need to pre-fund their HSA account so that they have a sufficient balance when making a medical purchase. This prefunding requirement often creates a frustrating experience when a user attempts to process a transaction. For example, an HSA issued card may be denied at point of sale when sufficient funds haven't been deposited in the HSA account. Approximately 20% of HSA accounts do not contain any funds and another 30% of HSA accounts are typically underfunded. As a result, half of HSA users are unable to derive the maximum tax benefits from their member accounts. As medical transactions accumulate, the missed tax benefits add up to a significant amount of money. Although HSAs were first introduced into law in 2003, they are underutilized and inefficiently managed by employers and individual members.

Advantageously, the system and method for processing transactions of the present disclosure allows individuals and employers to fund HSA-eligible purchases in a timely manner through a central operating account, thereby allowing members to access pre-tax funds without a balance in their individual member account. On the backend, a pre-tax payroll deduction can be made to the employer and allows for the central operating account to subsequently recover the pre-tax funds that were spent by individual members. This concept of a reverse HSA provides an improvement over conventional HSA systems and accounts because it facilitates tax savings in a buy now, pay later system. As a result, a user does not have to guess or preemptively predict the amount of money needed to be placed into an HSA account to cover future potential transactions.

There is a need for an efficient system and method for processing healthcare transactions using health savings accounts that maximizes tax benefits of an HSA while providing significant flexibility to individual members and companies participating in a high-deductible insurance plan with health savings accounts. Conventional HSAs are underutilized and inefficiently used by the end user and result in unrealized tax savings for the individual member and the employer. As a result, there is a need for a system and method that establishes and utilizes health savings accounts for payment of qualified medical expenses in an efficient manner, resulting in clear cost benefits to the end user.

The present disclosure also relates generally to a system and method that establishes and utilizes an individual coverage health reimbursement arrangement for payment of qualified medical expenses in an efficient manner. It is foreseeable that this disclosure may be tailored such that it allows individuals (i.e., members) and employers to customize different aspects of the system and method for processing transactions in an individual coverage health reimbursement arrangement based on user needs.

The subject matter described herein relates to maximizing cost savings and efficiently using an individual coverage health reimbursement arrangement to efficiently process medical transactions without requiring individual employees (i.e., members) to front the cost of their insurance premiums or other qualifying medical expenses with their own money. In general, individual coverage health reimbursement arrangements (“ICHRA”) are valuable plans that allow companies to reimburse their members, tax-free, for individual health insurance premiums and other qualifying medical expenses. Unlike conventional health reimbursement arrangements (“HRA”), funds from an ICHRA plan can be used to pay for individual healthcare insurance premiums (non-group policies). Under an ICHRA plan, employers reimburse the members on a weekly, monthly, quarterly, semi-annually, or some other time arrangement basis that is based on the employer and member employee's needs. Individual members that participate in the ICHRA plan can then use the funds to pay for premiums along with certain IRS-approved healthcare products and services (depending on how the employer's ICHRA plan is designed).

Under an ICHRA plan, the employer determines a reimbursement allowance for a given predetermined period of time and can set different allowance amounts for different classes of members based on certain parameters. For example, common parameters can include, but are not limited to, full-time or part-time employees; salaried vs. non-salaried employees; or geographic locations of employees. The employer may also set different allowance amounts within a class based on, for example, employees' ages or family sizes.

Under conventional ICHRA plans, members are required to pay the cost of their insurance premiums or other qualifying medical expenses with their own money. Thereafter, during an employer's payroll cycle, the employer reimburses the member for the amount spent by the member, provided that the member did not exceed the allocated reimbursement allowance set by the employer within the ICHRA plan. As a result, members need to front the cost of their insurance premiums or medical expenses until reimbursement. Additionally, purchases that exceed the member's allocated reimbursement allowance are often declined or result in accounting/taxation issues that become more complicated and burdensome because only a portion of the payments will be entitled to tax-free treatment. In order to address this, some ICHRA plans provide debit cards that members can use to fund purchases. However, the experience remains frustrating with respect to card declines, accounting issues, and taxation issues for both the member and the employer. As a result, although ICHRAs were first introduced into law in 2019, they are underutilized and inefficiently managed by employers and individual members.

Advantageously, under the system and method for processing transactions of the present disclosure, the employee (i.e., member) does not need to worry about whether they have sufficient money remaining in their ICHRA plan balance to fund their insurance premiums or eligible medical expenses because the system and method of the present disclosure can be integrated with an employer's payroll to ensure that there is always sufficient funding using a payment card linked to the employer's payroll. Specifically, on the backend, to the extent that an insurance premium or eligible medical expense exceeds an allocated reimbursement allowance for a given time period, a payroll deduction can be made directly through the employee's payroll to address any overage expenses. As a result, a member does not have to guess or worry about whether their ICHRA plan will cover a potential transaction or whether their card will be declined. It is to be understood that the system and method may also be configured to allow an employer to decline payments that exceed the allocated reimbursement allowance for a given time period.

There is a need for an efficient system and method for processing healthcare transactions using an individual coverage health reimbursement arrangement that maximizes tax benefits and reduces headaches associated with burdensome tax and accounting challenges resulting from card declines. Conventional ICHRAs are inefficiently used by employers and their member employees and result in unrealized tax savings and significant costs up front for a member. As a result, there is a need for a system and method that uses an individual coverage health reimbursement arrangement for payment of qualified medical expenses in an efficient manner, resulting in clear cost benefits to the end users, e.g., employers and member employees.

### SUMMARY

There is a need for a system and method for processing transactions in a health savings account and an individual coverage health reimbursement arrangement that addresses the aforementioned problems and unrealized tax savings associated with conventional systems and methods.

An embodiment of the present disclosure is a method of processing healthcare payments through a health savings account that includes receiving a transaction related to healthcare services via a payment card. The method also includes funding the transaction from a system operational account to the payment card. The method further includes recording an amount of the transaction into an invoice database, wherein each recorded amount corresponds to a generated invoice. It is to be understood that the generated invoice may contain one or more recorded amounts. The method also includes combining the generated invoices in the invoice database to calculate an aggregated employer invoice amount. The method includes debiting the aggregated employer invoice amount from an employer operating account. The method further includes paying the aggregated employer invoice amount into a system batch account and partially distributing a portion of the aggregated employer invoice amount from the system batch account to a plurality of member accounts. The method also includes initiating payment from each of the plurality of member accounts to the system operational account based on the transaction.

Another embodiment of the present disclosure is a method of processing healthcare payments through a health savings account for tax savings that includes receiving a transaction amount related to healthcare services via a payment card associated with an employee. The method also includes debiting the transaction amount from a system operational account and recording the transaction amount into a ledger database as a contribution transaction. The method further includes generating an aggregated employer invoice based on a collective sum of the contribution transactions associated with each employee of an employer. The method includes enrolling each employee into an employer-provided pre-tax benefit for the amount of the contribution transactions associated with each employee. The method also includes transferring an ACH transaction payment from the employer to a system batch account based on the aggregated employer invoice, the aggregated employer invoice being representative of the contribution transactions from all employees of the employer that are received within a predetermined period. The method further includes crediting each employee with a distribution amount based on a total number of contribution transactions associated with the employee within the predetermined period. The method includes initiating a first distribution transaction of the distribution amount of each employee from the system batch account to an HSA account associated with each employee. The method further includes initiating a second distribution transaction from the HSA account associated with each employee to the system operational account to cover the contribution transactions during the predetermined period for each employee.

Another embodiment of the present disclosure is a method of processing healthcare payments through a health savings account performed by at least one control device, the control device being in communication with a communications network. The method includes receiving, by the control device, a transaction related to healthcare services via a payment card. The method also includes funding, by the control device, the transaction from a system operational account to the payment card. The method includes recording, by the control device, an amount of the transaction into an invoice database, wherein each recorded amount corresponds to a generated invoice. It is to be understood that the generated invoice may contain one or more recorded amounts. The method further includes combining, by the control device, the generated invoices in the invoice database to calculate an aggregated employer invoice amount. The method includes debiting, by the control device, the aggregated employer invoice amount from an employer operating account. The method includes paying, by the control device, the aggregated employer invoice amount into a system batch account. The method further includes partially distributing, by the control device, a portion of the aggregated employer invoice amount from the system batch account to a plurality of member accounts. The method includes initiating, by the control device, payment from each of the plurality of member accounts to the system operational account based on the transaction.

Another embodiment of the present disclosure is a system comprising a system database, an invoice database, a member database, a payment card, and a software application. The system database contains an operating account and a batch account connected to a host server. The invoice database contains a ledger, wherein the invoice database is in communication with the host server. The member database contains an employer operating account and a plurality of member accounts associated with each employee of an employer, wherein the member database is in communication with the host server. The payment card is issued to each employee of the employer. The software application is configured to receive a transaction related to healthcare services via the payment card. The software application is also configured to fund the transaction from the operating account on the system database to the payment card. The software application is further configured to record an amount of the transaction into the invoice database and generate an invoice. It is to be understood that the generated invoice may contain one or more recorded amounts. The software application is also configured to combine the generated invoices in the invoice database to calculate an aggregated employer invoice amount. The software application is configured to debit the aggregated employer invoice amount from the employer operating account on the member database and pay the aggregated employer invoice amount into the batch account on the system database. The software application is further configured to partially distribute a portion of the aggregated employer invoice amount from the batch account to the plurality of member accounts on the member database. The software application is also configured to initiate payment from each of the plurality of member accounts to the operating account on the system database based on the transaction.

An embodiment of the present disclosure is a method of processing healthcare payments through an individual coverage health reimbursement arrangement that includes receiving a transaction related to a qualified medical expense via a payment card linked to a member checking account. The method also includes funding an amount corresponding to the transaction from a funding account to the member checking account, wherein the funding account is a system operational account, an employer-owned account or a member-owned account. The method further includes transferring the amount from the member checking account to a seller associated with the transaction. The method also includes recording the amount of the transaction into an invoice database, wherein each recorded amount corresponds to a generated invoice. It is to be understood that the generated invoice may contain one or more recorded amounts. The method further includes combining the generated invoices in the invoice database to calculate an aggregated employer invoice amount at the end of a predetermined period based on a collective sum of the transactions associated with each member of an employer. The method includes debiting the aggregated employer invoice amount from an employer operating account for the predetermined period. The method also includes paying the aggregated employer invoice amount into a system batch account and initiating a transfer from the system batch account to the funding account.

Another embodiment of the present disclosure is a method of processing healthcare payments through an individual coverage health reimbursement arrangement for tax savings that includes receiving an authorization request related to a medical expense via a payment card associated with a member checking account. The method also includes determining whether the medical expense is a qualified medical expense. The method further includes transferring an amount corresponding to the medical expense from a funding account to the member checking account, wherein the funding account is a system operational account, an employer-owned account or a member-owned account. The method includes approving the authorization request and placing a hold on the member checking account based on the member's reimbursable amount corresponding to the medical expense. The method also includes creating a transaction based on the authorization request. The method further includes transferring the amount from the member checking account to a seller associated with the transaction and canceling the hold on the member checking account. The method includes recording the amount of the transaction into an invoice database, wherein each recorded amount corresponds to a generated invoice. It is to be understood that the generated invoice may contain one or more recorded amounts. The method further includes creating an overage invoice if the amount of the transaction exceeds a balance associated with the member checking account. The method includes combining the generated invoices in the invoice database to calculate an aggregated employer invoice amount at the end of a predetermined period based on a collective sum of the transactions associated with each member of an employer. The method also includes debiting the aggregated employer invoice amount from an employer operating account for the predetermined period. The method further includes paying the aggregated employer invoice amount into a system batch account. The method includes initiating a transfer from the system batch account to the funding account.

Another embodiment of the present disclosure is a method of processing healthcare payments through an individual coverage health reimbursement arrangement performed by at least one control device, the control device being in communication with a communications network. The method includes receiving, by the control device, a transaction related to a qualified medical expense via a payment card linked to a member checking account. The method includes funding, by the control device, an amount corresponding to the transaction from a funding account to the member checking account, wherein the funding account is a system operational account, an employer-owned account or a member-owned account. The method also includes transferring, by the control device, the amount from the member checking account to a seller associated with the transaction. The method further includes recording, by the control device, the amount of the transaction into an invoice database, wherein each recorded amount corresponds to a generated invoice. It is to be understood that the generated invoice may contain one or more recorded amounts. The method also includes combining, by the control device, the generated invoices in the invoice database to calculate an aggregated employer invoice amount at the end of a predetermined period based on a collective sum of the transactions associated with each member of an employer. The method includes debiting, by the control device, the aggregated employer invoice amount from an employer operating account for the predetermined period. The method further includes paying, by the control device, the aggregated employer invoice amount into a system batch account. The method also includes initiating, by the control device, a transfer from the system batch account to the funding account.

Another embodiment of the present disclosure is a system comprising a system database, an invoice database, a member database, a payment card, and a software application. The system database contains a funding account and a batch account connected to a host server, wherein the funding account is a system operational account, an employer-owned account or a member-owned account. The invoice database contains a ledger, wherein the invoice database is in communication with the host server. The member database contains an employer operating account and a plurality of member checking accounts associated with each member of an employer, wherein the member database is in communication with the host server. The payment card is issued to each member of the employer. The software application is configured to receive a transaction related to a qualified medical expense via the payment card linked to the member checking account of a member. The software application is also configured to fund an amount corresponding to the transaction from the funding account on the system database to the member checking account. The software application is further configured to transfer the amount from the member checking account to a seller associated with the transaction. The software application is configured to record the amount of the transaction into the invoice database, wherein each recorded amount corresponds to a generated invoice. It is to be understood that the generated invoice may contain one or more recorded amounts. The software application is also configured to combine the generated invoices in the invoice database to calculate an aggregated employer invoice amount at the end of a predetermined period based on a collective sum of the transactions associated with each member of an employer. The software application is configured to debit the aggregated employer invoice amount from the employer operating account for the predetermined period. The software application is further configured to pay the aggregated employer invoice amount into the batch account on the system database. The software application is also configured to initiate a transfer from the batch account to the funding account.

The systems and methods as described herein are not limited for use with health savings accounts and individual coverage health reimbursement arrangements.

### BRIEF DESCRIPTION OF THE DRAWINGS

The foregoing summary, as well as the following detailed description of illustrative embodiments of the present disclosure, will be better understood when read in conjunction with the appended drawings. For the purposes of illustrating the present application, there are shown in the drawings, illustrative embodiments of the disclosure. It should be understood, however, that the application is not limited to the precise arrangements and instrumentalities shown. In the drawings:

FIG. 1 is a process flow diagram illustrating an exemplary method for processing healthcare payments through a health savings account according to an embodiment of the present disclosure;

FIG. 2 is a process flow diagram illustrating another exemplary method for processing healthcare payments through a health savings account according to an embodiment of the present disclosure;

FIG. 3 is a process flow diagram illustrating an exemplary method of funding a health savings account via a personal account according to an embodiment of the present disclosure;

FIG. 4 is a process flow diagram illustrating an exemplary method of funding a health savings account via payroll deductions according to an embodiment of the present disclosure;

FIG. 5 is a process flow diagram illustrating an exemplary method of issuing payments from a member HSA account according to an embodiment of the present disclosure;

FIG. 6 is a process flow diagram illustrating an exemplary method of issuing payments from a payroll deduction according to an embodiment of the present disclosure;

FIG. 7 is a process flow diagram illustrating an exemplary method of setting up a system for processing healthcare payments according to an embodiment of the present disclosure;

FIG. 8 is a block diagram of an exemplary configuration of the system for processing healthcare payments according to an embodiment of the present disclosure;

FIG. 9 is a process flow diagram illustrating exemplary methods of funding a health savings account according to an embodiment of the present disclosure;

FIG. 10 is a process flow diagram illustrating an exemplary method for processing healthcare payments through an individual coverage health reimbursement arrangement according to an embodiment of the present disclosure;

FIG. 11 illustrates an example graphical user interface depicting an exemplary method of setting up a system for processing healthcare payments according to an embodiment of the present disclosure;

FIG. 12 illustrates another example graphical user interface depicting an exemplary method of setting up a system for processing healthcare payments according to an embodiment of the present disclosure;

FIG. 13 is a process flow diagram illustrating an exemplary method for processing healthcare payments through an individual coverage health reimbursement arrangement according to an embodiment of the present disclosure;

FIG. 14 is a process flow diagram illustrating an exemplary method of issuing reimbursements from an individual coverage health reimbursement arrangement according to an embodiment of the present disclosure;

FIG. 15 is a process flow diagram illustrating an exemplary method for processing healthcare payments through an individual coverage health reimbursement arrangement according to an embodiment of the present disclosure; and

FIG. 16 is a process flow diagram illustrating an exemplary method for processing healthcare payments through an individual coverage health reimbursement arrangement according to an embodiment of the present disclosure.

### DETAILED DESCRIPTION OF ILLUSTRATIVE EMBODIMENTS

Reference will now be made in detail to the exemplary embodiments of the present disclosure illustrated in the accompanying drawings. Wherever possible, the same or like reference numbers will used throughout the drawings to refer to the same or like features. It should be noted that the drawings are in simplified form and are not drawn to precise scale. In reference to the disclosure herein, for purposes of convenience and clarity only, directional terms such as top, bottom, left, right, above, below and diagonal, are used with respect to the accompanying drawings. Such directional terms used in connection with the following description of the drawings should not be construed to limit the scope of the present disclosure in any manner not explicitly set forth. Additionally, the term “a,” as used in the specification, means “at least one.” The terminology includes the words above specifically mentioned, derivatives thereof, and words of similar import.

Furthermore, the described features, advantages and characteristics of the exemplary embodiments may be combined in any suitable manner in one or more embodiments. One skilled in the art will recognize, in light of the description herein, that the exemplary embodiments can be practiced without one or more of the specific features or advantages of a particular embodiment. In other instances, additional features and advantages may be recognized in certain embodiments that may not be present in all embodiments of the present disclosure.

Embodiments of the present disclosure include a system, method, and related software application for processing transactions in a health savings account over a communications network. Embodiments of the present disclosure include a system, method, and related software application for processing healthcare transactions in an individual coverage health reimbursement arrangement over a communications network. The systems, methods, and related software application as described herein may be used to fund health savings accounts through an employer payroll deduction or through other funding sources from an individual. The systems, methods, and related software application as described herein may also be used to efficiently utilize individual coverage health reimbursement arrangements through an employer. It should be appreciated that the systems, methods, and software applications can be customized based on the needs of an employer and its members.

In conventional health savings accounts (“HSA”), members contribute tax-free payroll deductions in their HSA to pay for future medical expenses now, then buy later. As a result, HSAs are often underutilized because they are poorly understood, hard to use, and involve friction to estimate future medical expenses. Advantageously, the present disclosure provides a system and method where healthcare is purchased now, an exact amount of which is paid for later through a tax-free payroll deduction. This would allow the ideal member or user to swipe a payment card and automatically receive a discount on all healthcare purchases while benefiting from the tax savings associated with health savings accounts.

For low-income earners, such a system would provide increased access to unaffordable healthcare and remove uncertainty of estimating healthcare expenses in advance. Additionally, unused portions would not be tied up in a traditional HSA. For high-income earners, the system would facilitate larger discounts with expensive doctors, remove uncertainty of estimating healthcare expenses in advance, and allow for enrollment into a high deductible health plan to save money on monthly contributions.

As described further below, members can deposit funds into their HSA accounts through a variety of methods including, but not limited to, personal checking accounts and payroll deductions. Payments can made through an issued payment card that can be funded through an HSA account or a payroll deduction. It is to be understood that ACH payments can also be made through an individual's personal bank account. The system includes a system database containing an operating account and a batch account connected to a host server. The system further includes an invoice database containing a ledger and a member database containing an employer operating account and a plurality of member accounts associated with an employee of an employer. Finally, the system may include a payment card issued to an employee of the employer that is associated with their respective member accounts.

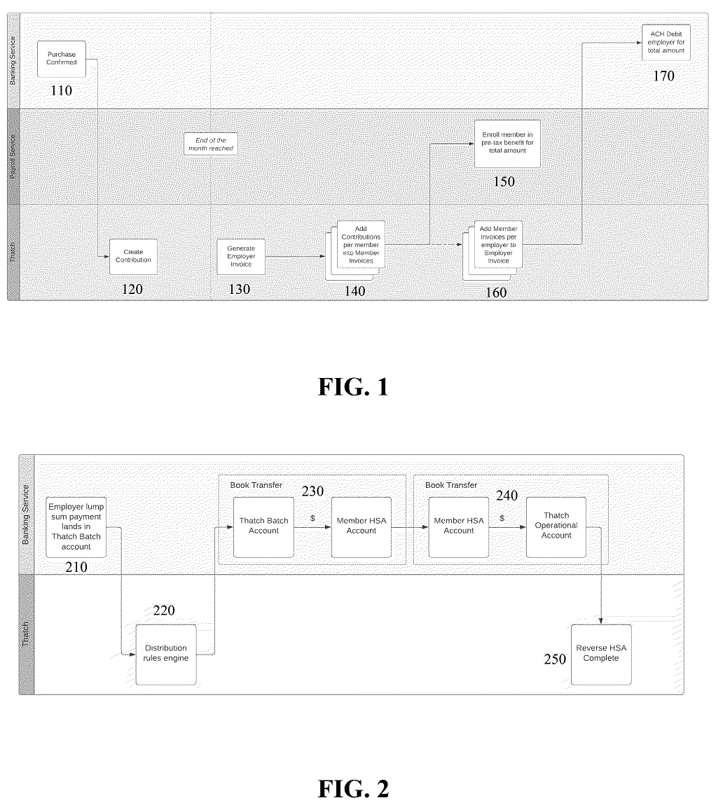

Referring now to FIG. 1, there is shown a process flow diagram illustrating an exemplary method for processing healthcare payments through a health savings account according to an embodiment of the present disclosure. Specifically, FIG. 1 identifies how payroll deductions are tracked and billed to employers monthly using the system of the present disclosure. Generally speaking, in the case of a reverse HSA transaction, the system database confirms a purchase (step 110) and funds the transaction from its operational account. Each transaction is represented internally as a contribution. This contribution is created on the system (step 120). At the end of a given period of time (e.g., a month), an employer invoice is generated (step 130). Specifically, the system database and invoice database tally all of a member's contributions into a single generated invoice on a per member basis (step 140). Thereafter, the system enrolls the member into a pre-tax benefit for the total amount (step 150). That amount is subsequently withdrawn from a member's paycheck in the next payroll cycle. Simultaneously, the system appends the member invoices into an aggregated employer invoice (step 160) which tracks the total amount to be debited from the employer. Thereafter, an ACH transaction (step 170) is created to charge the employer for the total amount of all contributions by their members and the company during the predetermined period or payroll cycle.

Referring now to FIG. 2, there is shown a process flow diagram illustrating another exemplary method for processing healthcare payments through a health savings account according to an embodiment of the present disclosure. Specifically, FIG. 2 identifies how payments are received from the employer and routed through the reverse HSA flow of funds. The employer ACH transaction lands into the system batch account (step 210). Upon receipt, based on a rules engine, past contributions per member are reviewed to determine which members should receive distributions (step 220). The system then initiates a first book transfer i.e., first distribution transaction, from the system batch account to the member HSA account, thereby fulfilling the pre-tax funding requirements to maintain the HSA (step 230). Immediately thereafter, the system initiates a second book transfer, i.e., second distribution transaction, from the member HSA account to the system operational account to cover the initial transaction (step 240). The system creates the second distribution transaction to represent the funds leaving the HSA. Once the funds have settled into the system operational account, the reverse HSA process is complete (step 250).

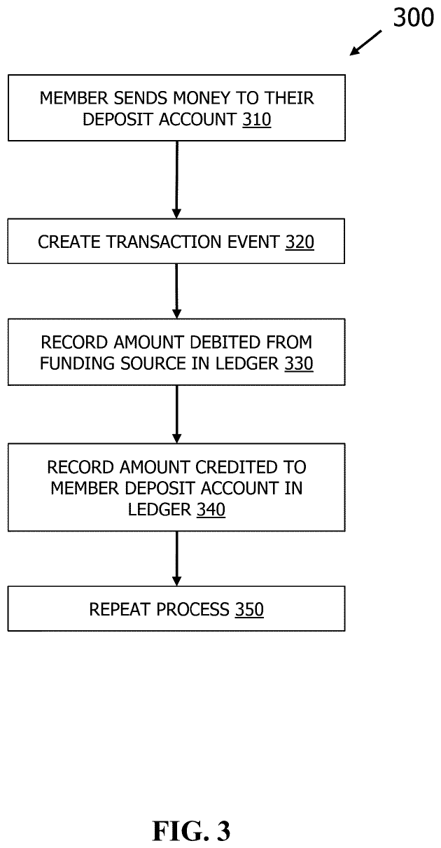

Referring now to FIGS. 3-6, there are shown process flow diagrams illustrating exemplary methods of funding a health savings account via a personal account, funding a health savings account via payroll deductions, issuing payments from a member HSA account, and issuing payments from a payroll deduction, all according to an embodiment of the present disclosure.

As shown in FIG. 3, a member can fund a health savings account through their personal checking account. The member first sends money to their deposit account (step 310) using the routing and account number of their deposit account. Upon sending the money, a transaction event is created (step 320). The system then records the amount debited from the funding source in the ledger database (step 330). Similarly, the system then records the amount credited to the member deposit account in the ledger database (step 340). This process may be repeated (step 350) as desired to regularly ensure that the member deposit account has sufficient funds.

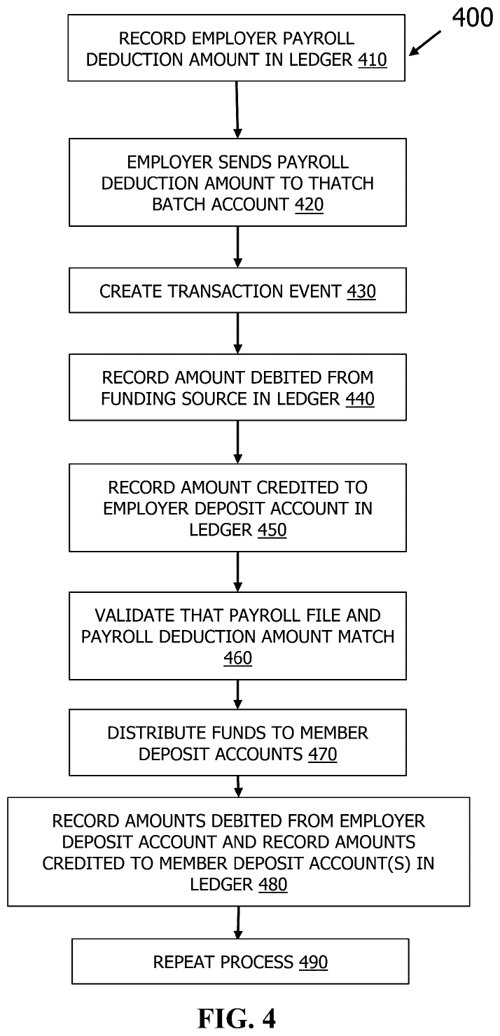

As shown in FIG. 4, a member can fund a health savings account via payroll deductions. Upon establishing the total payroll deduction amount, the system records the employer payroll deduction amount in the ledger database (step 410). The employer sends the payroll deduction amount to the system batch account (step 420). Upon sending the money, a transaction event is created (step 430). The system then records the amount debited from the funding source in the ledger database (step 440). Similarly, the system then records the amount credited to the employer deposit account in the ledger database (step 450). After validating that the payroll file and payroll deduction amount match (step 460), the system distributes the funds to each of the member deposit accounts (step 470). Subsequently, another set of transaction events are created. The system then records the amounts debited from the employer deposit account and records the amounts credited to each of the member deposit accounts in the ledger database (step 480). This process may be repeated (step 490) per payroll period to ensure that the member deposit account has sufficient funds.

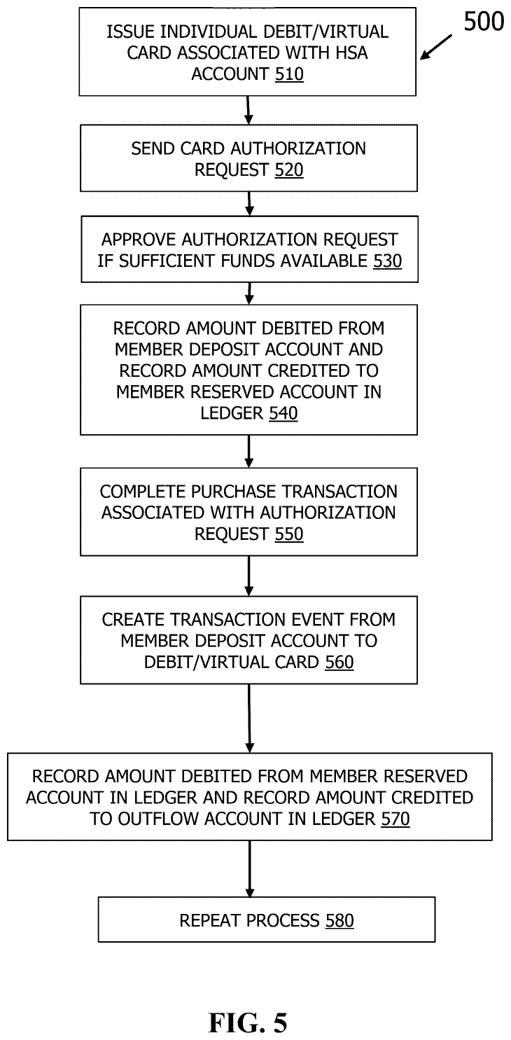

As shown in FIG. 5, a member can have payments issued from the member's HSA account. An individual debit card or virtual card associated with a member HSA account, e.g., member deposit account, is issued to each member (step 510). It is to be understood that the member can use this payment card, e.g., debit card or virtual card, to enter into any healthcare transactions. Upon swiping the payment card, a card authorization request is sent to the system (step 520). An application programming interface (“API”) call can be made by the system to determine if sufficient funds are available in the member deposit account. Assuming sufficient funds are available, the authorization request is approved (step 530). A transaction event is created, and the system records the amount debited from the member deposit account and records the amount credited to a member reserved funds account in the ledger database (step 540). Shortly after the authorization request, the transaction purchase associated with the authorization request is completed (step 550). The system then creates another transaction event from the member deposit account to the payment card (step 560) to complete the transaction purchase. The system then records the amount debited from the member reserved funds account in the ledger database and records the amount credited to an outflow account in the ledger database (step 570). Once again, this process may be repeated for each transaction on the issued payment card (step 580).

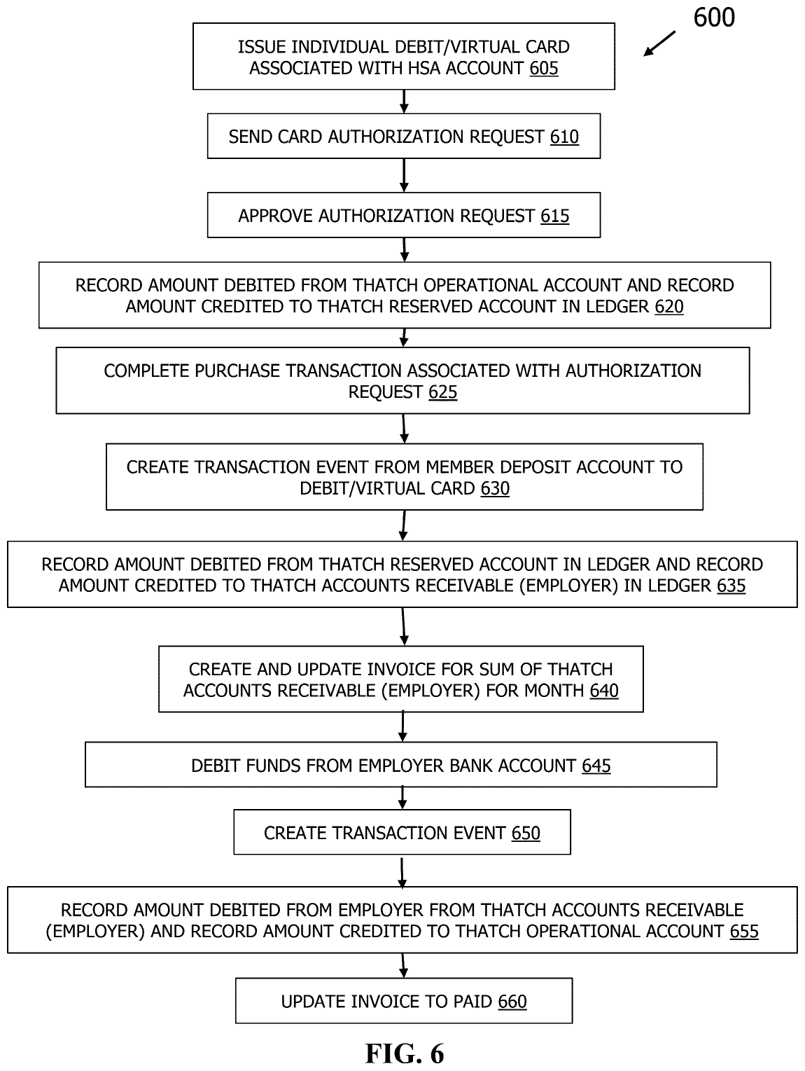

As shown in FIG. 6, a member can have payments issued from a payroll deduction. An individual debit card or virtual card associated with a member HSA account, e.g., member deposit account, is issued to each member (step 605). It is to be understood that the member can use this payment card, e.g., debit card or virtual card, to enter into any healthcare transactions. Upon swiping the payment card, a card authorization request is sent to the system (step 610). The system then approves the card authorization request (step 615). The system then records the amount debited from the system operational account and records the amount credited to a system reserved account in the ledger database (step 620). The transaction purchase associated with the authorization request is then completed (step 625). The system then creates a transaction event from the member deposit account to the issued payment card (step 630). The system then records the amount debited from the system reserved account in the ledger database and records the amount credited to an employer's accounts receivable in the ledger database (step 635). At the end of a predetermined period, the system creates and updates an invoice record for the sum of the employer's accounts receivable (step 640). The system then debits funds from an employer's bank account based on the invoice record (step 645). The funds may be debited via an ACH payment, for example. A transaction event is then created (step 650). Thereafter, the system records the amount debited from the employer's accounts receivable in the ledger database and records the amount credited to the system operational account in the ledger database (step 655). Finally, the system then updates the invoice record to paid status (step 660).

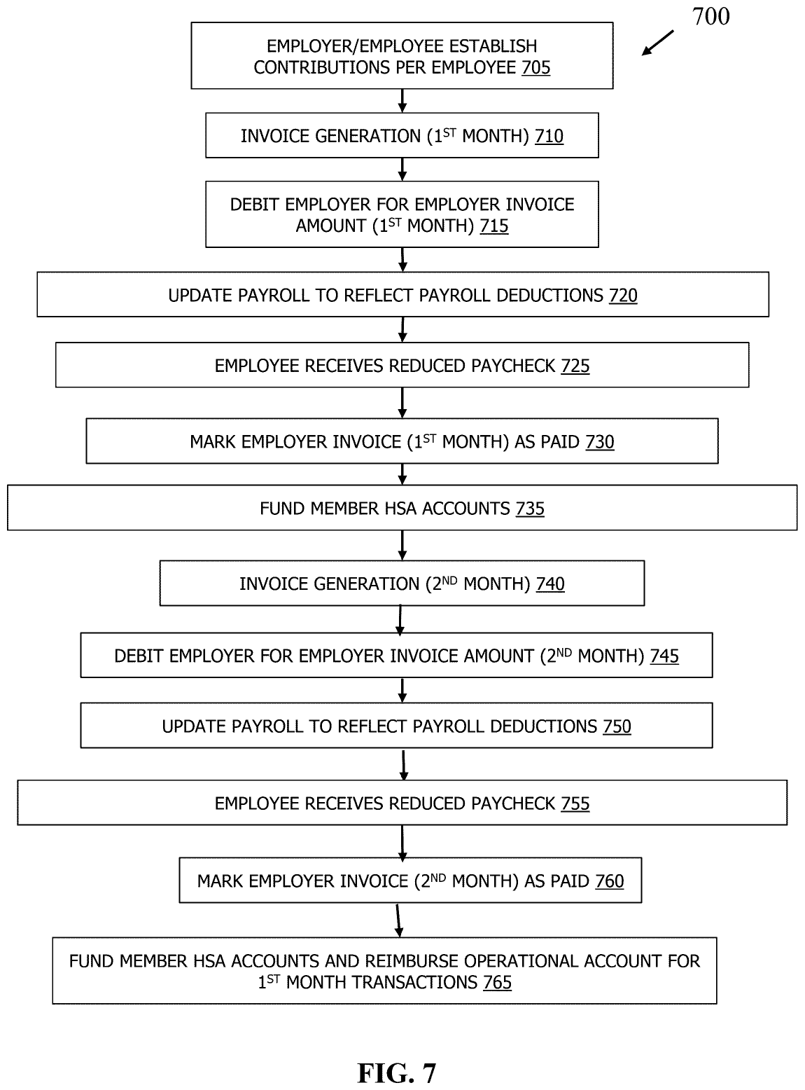

Referring now to FIG. 7, there is shown a block diagram of an exemplary configuration of the system for processing healthcare payments according to an embodiment of the present disclosure. Specifically, FIG. 7 illustrates a data model illustrating how the funds flow with contributions and expenses in a payroll deduction plan associated with member deposit accounts, i.e., HSA accounts. The employer and employee first establish a contribution amount to make on a per employee basis (step 705). Thereafter, once the contribution period starts (e.g., when the employer and employee contribute to the HSA), invoices are generated (step 710). That is, based on the pre-tax contribution for each employee, a per member invoice (sum of member's contributions) and an employer invoice (aggregation of member invoices for all employees) is generated. Subsequently, the system debits the employer for the employer invoice amount (step 715). Thereafter, the payroll system of the employer is updated to reflect the payroll deductions based on the member invoices (step 720). As a result, each employee receives a reduced paycheck (step 725). After the employer invoice amount is sent, the employer invoice is marked as paid (step 730). Thereafter, the funds are distributed to each of the member HSA accounts (step 735). This process is then repeated when the next contribution period starts. That is, invoices are once again generated (step 740). The system then debits the employer for the updated employer invoice amount (step 745). The payroll system of the employer is once again updated to reflect the payroll deductions based on the updated member invoices (step 750). Similar to the previous payroll period, the employee receives a reduced paycheck as a result of the payroll deductions (step 755). After the updated employer invoice amount is sent, the updated employer invoice is marked as paid (step 760). Finally, the funds are then distributed to each of the member HSA accounts and the system operational account is reimbursed for the previous payroll period's transactions (step 765).

It is to be understood that the payroll period can be adjusted as well as other aspects of the system for processing healthcare payments through a health savings account. For example, the system may be customized such that employers may alternate between lump sum contributions and flat rate contributions. Additionally, there may need to be different monthly contribution amounts for each employee to account for other factors such as single/family or catchup contributions. A contribution is created for whenever money enters a member HSA account. For example, a pre-tax contribution is created for HSA eligible payment card transactions and funding contributions from an employee or employer via payroll deductions. A post-tax contribution is created for HSA ineligible payment card transactions and an overage funding contribution. Such an overage funding contribution may occur when a member has reached their HSA contribution limit.

In accordance with an aspect of the present disclosure, card authorizations may have recorded funding preferences based on predetermined user settings. These funding preferences can include whether the transaction should be funded through HSA, future payroll, or an external account. It is contemplated that future iterations of the system may allow for employees to fund a health savings account via an external ACH payment or a card purchase could be funded by an employee's external bank account. Similarly, the system may account for ACH return transactions, canceled card authorizations and declined card authorizations.

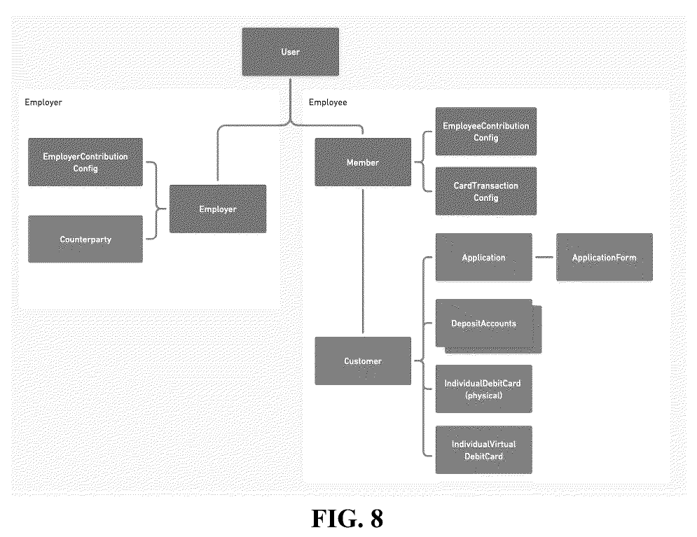

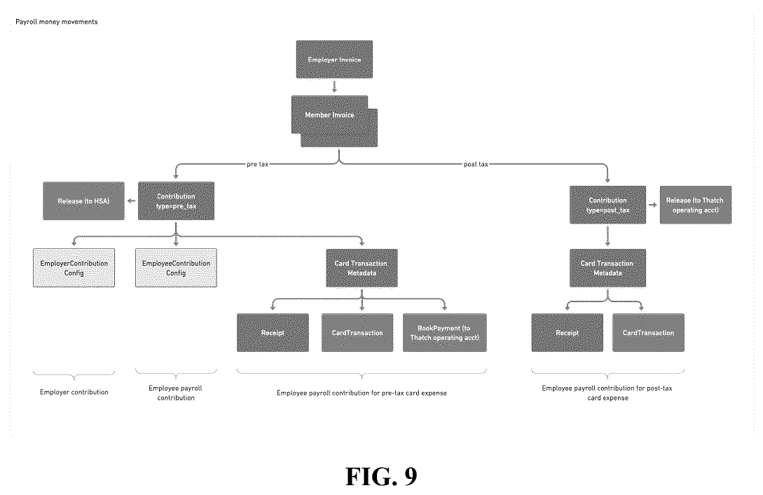

Referring now to FIG. 8, there is shown a user data model according to an embodiment of the present disclosure. Specifically, FIG. 8 is a block diagram of an exemplary configuration of the system for processing healthcare payments. As discussed above in the various process flow diagrams, the contributions can be made through employee or employer contributions and payments can be made through individual debit card or virtual cards. Referring now to FIG. 9, there is shown a process flow diagram illustrating exemplary methods of funding a health savings account. Specifically, FIG. 9 identifies the various funding methods previously discussed as well as the components of the system involved in the processing of the transactions. FIG. 9 indicates how the employer invoices are broken down into employer contributions, employee payroll contributions, employee payroll contributions for pre-tax card expenses and employee payroll contributions for post-tax card expenses. It is to be understood that the process and flow diagrams described above are not provided as limiting to the present disclosure. That is, the system may be customized or changed to include other components and be further customized for each customer.

In sum, the present disclosure includes a method of processing healthcare payments through a health savings account. The steps include receiving a transaction related to healthcare services via a payment card. The transaction is then funded from a system operational account to the payment card. This transaction is then recorded into an invoice database, wherein each recorded amount corresponds to a generated invoice. It is to be understood that the generated invoice may contain one or more recorded amounts. The generated invoices are then combined in the invoice database to calculate an aggregated employer invoice amount that is subsequently debited from an employer operating account. The debited amount is paid into a system batch account and then distributed from the system batch account to a plurality of member accounts based on the generated invoices. Finally, a payment is initiated from each of the member accounts to the system operational account based on the transaction. The step of partially distributing a portion of the aggregated employer invoice amount can further include analyzing the invoice database to determine an exact portion of the aggregated employer invoice amount that is distributed to each of the plurality of member accounts. In accordance with an aspect, the step of receiving a transaction related to healthcare services via a payment card, further includes receiving a plurality of transactions related to healthcare services via a plurality of payment cards associated with each of the plurality of member accounts. Additionally, the payment card is issued to an employee with each of the plurality of member accounts and the payment card is associated with a member HSA account.

In accordance with another aspect, the method may include receiving a transaction related to healthcare services via a payment card. The transaction amount is then debited from a system operational account and the transaction amount is recorded into a ledger database as a contribution transaction. As discussed above, an aggregated employer invoice is generated based on a collective sum of the contribution transactions from each employee. Thereafter, each employee is enrolled into an employer provided pre-tax benefit payroll deduction based on the contribution transactions. An ACH payment is then made from the employer to a system batch account based on the aggregated employer invoice. It is important to note that the aggregated employer invoice is representative of the contribution transactions from all employees of the employer within a predetermined period (e.g., a payroll period). The system then credits each employee HSA account with a distribution amount based on the contribution transactions. This first distribution transaction moves from the system batch account to the employee HSA account. Finally, a second distribution transaction from each employee HSA account to the system operational account is made to cover all of the contribution transactions for the predetermined period. This process can be repeated during every predetermined period (e.g., payroll period).

In accordance with another aspect, it is to be further understood that a control device in communication with a communications network may perform the method of processing healthcare payments through a health savings account. That is, the method may include receiving, by the control device, a transaction related to health care services via a payment card. The control device may be used to fund the transaction from a system operational account to the payment card and record an amount of the transaction into an invoice database. Similar to previous embodiments, each recorded amount corresponds to a generated invoice. It is to be understood that the generated invoice may contain one or more recorded amounts. The control device may then combine the generated invoices in the invoice database to calculate an aggregated employer invoice amount, which is debited from an employer operating account. The method further includes paying, by the control device, the aggregated employer invoice amount into a system batch account. Thereafter, the control device may partially distribute a portion of the aggregated employer invoice amount from the system batch account to a plurality of member accounts. Finally, the method includes initiating, by the control device, payment from each of the plurality of member accounts to the system operational account based on the transaction.

In accordance with another aspect of the present disclosure, the system includes a system database, an invoice database, a member database, a payment card, and a software application hosted on a cloud. The system database contains an operating account and a batch account connected to a host server. The invoice database contains a ledger, wherein the invoice database is connected to the host server. The member database contains an employer operating account and a plurality of member accounts associated with each employee of an employer. The member database is also in communication with the host server. The payment card may be a physical debit card or a virtual card issued to each employee and associated with a member account. Although the software application may be hosted on the system database, the invoice database, or the member database, it is preferably hosted on the cloud. The software application also facilitates communication between the multiple databases discussed above. It is to be understood that one or more of the functional databases discussed above may be used to implement one or more aspects of the methods described herein.

The software application is configured to receive a transaction related to healthcare services via the payment card, fund the transaction from the operating account on the system database to the payment card, record an amount of the transaction into the invoice database and generate an invoice, combine the generated invoices in the invoice database to calculate an aggregated employer invoice amount, and debit the aggregated employer invoice amount from the employer operating account on the member database. The software application is further configured to pay the aggregated employer invoice amount into the batch account on the system database, partially distribute a portion of the aggregated employer invoice amount from the batch account to the plurality of member accounts on the member database, and initiate payment from each of the plurality of member accounts to the operating account on the system database based on the transaction. In accordance with an aspect, the system may further comprise a computer process configured to execute the software application.

In conventional individual coverage health reimbursement arrangements (“ICHRA”), employers reimburse employees, tax-free, for individual health insurance premiums and other qualifying medical expenses depending on the design of the ICHRA plan. Such a system allows an employer to set different reimbursement allowances for different classes of employees. As described further below, the reimbursement allowance for the ICHRA plan refers to the amount of money set aside by employers that will be available to employees (i.e., members) during a predetermined period of time. For example, this could be tied to the payroll cycle of an employer. However, it is to be understood that the predetermined period of time is independent of payroll cycle and does not necessarily need to be defined by the payroll cycle. Additionally, the balance for the ICHRA plan refers to the amount of money remaining in the member's ICHRA balance during the predetermined period. In use, the balance depletes as a member spends money towards health insurance premiums and other qualifying medical expenses. In general, ICHRA plans enable employers to save money by allowing to set particular allowances for different classes of members, rather than purchasing a one-size-fits-all package for all members. However, conventional ICHRA plans require members to pay the cost of insurance premiums or other qualifying medical expenses up front with their own money. Thereafter, the employer reimburses the member for an amount spent by the member, assuming they do not spend more than their allotted ICHRA reimbursement allowance.

However, purchases that exceed a member's ICHRA reimbursement allowance often result in declined cards and accounting/taxation issues that become more complicated and burdensome to the employer and the member. Advantageously, the present disclosure provides a system and method where qualified purchases are funded with a card while simultaneously integrating with the employee's payroll to avoid overage declines and other accounting/taxation issues. That is, with the system and method provided by the present disclosure, the employee (i.e., member) does not need to worry about whether they have sufficient funds in their ICHRA balance to fund any qualified purchases because the provided system and method is integrated with the employee's payroll to ensure that sufficient funding is always available. It is to be understood that the provided system and method can also be integrated with other forms of funding such as a member-owned bank account to cover spending in excess of a reimbursement allowance. For example, in the absence of employment or a recent termination of an employee's employment, the provided system and method can be integrated with a member-owned bank account to ensure that sufficient funding is always available.

The provided system and method of the present disclosure describes funding a member checking account associated with an employee and employer. However, it is to be understood that the provided system and method can be similarly used to fund a non-member checking account when a member checking account is not available. For example, in the absence of employment or a recent termination of an employee's employment, payments may be funded through a non-member checking account.

As further discussed below, each member of an employer is provided with a member checking account and the member checking account is funded before an insurance premium or qualified medical purchase. It is to be understood that the member checking account can be funded by a system operational account, an employer-owned account, a member-owned account or a combination thereof. Thereafter, the employer reimburses the system either during its payroll period or during a customized reimbursement cycle. This eliminates the need for members to have available funds and the requirement to pay for the cost of insurance to enjoy the benefits provided, including tax-free reimbursement of amounts paid for insurance premiums.

Certain features and components that are described above in the context of the system and related methods for processing transactions in a health savings account are related to certain features and components described below in the context of the system and related methods for processing transactions in an individual coverage health reimbursement arrangement. While the disclosure is described herein, using a limited number of exemplary embodiments, these specific embodiments are not intended to limit the scope of the disclosure as otherwise described and claimed herein. It is to be understood that various features described in the context of perhaps one implementation can also be implemented in multiple combinations separately or in any suitable sub-combination.

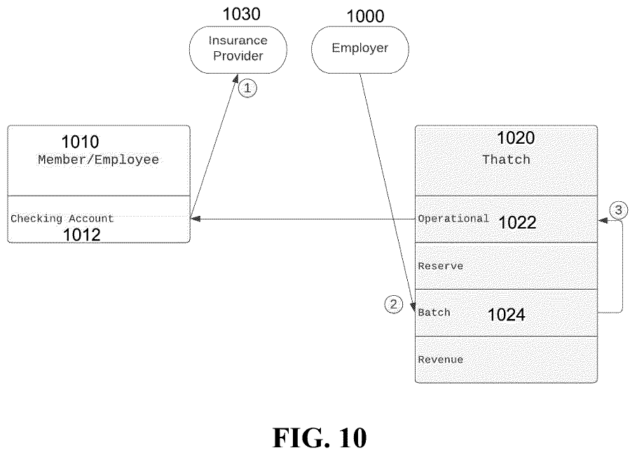

Referring now to FIG. 10, there is shown a process flow diagram illustrating an exemplary method for processing healthcare payments through an individual coverage health reimbursement arrangement according to an embodiment of the present disclosure. Specifically, FIG. 10 identifies how the ICHRA plan is implemented with an employer and its members using the system of the present disclosure. First, when an employer 1000 signs up to provide the system 1020 to its members 1010, the employer 1000 sets a reimbursement allowance for each of its classes of members 1010. Thereafter, when a member 1010 enrolls in the ICHRA plan offered by the employer 1000, the system 1020 provides a member checking account 1012 specific to the member 1010.

When the member 1010 purchases insurance or another qualified medical expense, the system 1020 sends the purchase amount from a funding account, e.g., system operational account 1022 to the member checking account 1012. Immediately thereafter, the system funds the purchase using the purchase amount in the member checking account 1012. Specifically, the purchase amount is sent from the member checking account 1012 to an insurance or medical expense provider 1030. Thereafter, at the time of payroll (or on another customized reimbursement cycle), the system pulls funds from an employer's operating account (not shown) and sends that to a system batch account 1024. Upon notice of a purchase, the system 1020 will determine if the member 1010 has exceeded the allotted reimbursement allowance established by the employer 1000. If the member 1010 still has an ICHRA balance remaining, then the funds are treated as pre-tax and will not impact the upcoming payroll. If the purchase exceeds the member's ICHRA balance, those funds are deducted from payroll. While the deduction from payroll may be treated as post-tax, it is to be understood and foreseeable that it may be treated as pre-tax for health insurance plans that are purchased outside of a health insurance exchange. Finally, the system then moves the purchase amount from the system batch account 1024 to the system operational account 1022, thereby repaying the balance initially transferred from the system operational account 1022 in connection with the transaction. As discussed herein, the funding account can be a system operational account, an employer-owned account, a member-owned account or a combination thereof.

Advantageously, this procedure reduces the potential for the ICHRA plan member's payments to be declined. Moreover, it reduces the burdensome tax and accounting challenges if their attempted payments exceed their ICHRA balance. Thus, the system and method of the present disclosure accounts for overage charges by dynamically pulling funds from either the employer (if under the ICHRA balance) or from the member's payroll (if over the ICHRA balance).

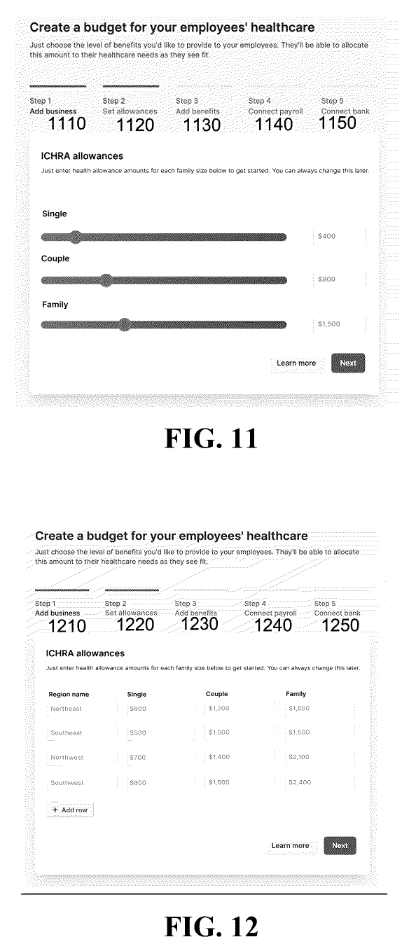

As previously discussed, there are several ways for employers to determine an allotted reimbursement allowance for its members enrolled in the ICHRA plan. Referring now to FIGS. 11 and 12, there are shown example graphical user interfaces depicting exemplary methods of setting up a system for processing healthcare payments according to an embodiment of the present disclosure. Specifically, FIGS. 11 and 12 identify how an employer may enroll in the ICHRA plan of the present disclosure and set reimbursement allowances for different groups. First, the employer adds its company business (step 1110). Thereafter, the employer can set reimbursement allowances based on family size, for example (step 1120). Then, the employer can add any desired benefits to include in the ICHRA plan (step 1130). Upon setting the initial parameters, the system and method can be connected to the employer and member's payroll (step 1140). Finally, the employer's bank information can be linked to the system so that the system and method becomes operational (step 1150).

Similarly, as shown in FIG. 12, the employer can also identify reimbursement allowances based on multiple criteria, geography and family size, for example. As discussed above, the employer adds its company business (step 1210). Thereafter, the employer can set reimbursement allowances based on family size and geographic region (step 1220). Then, the employer can add any desired benefits to include in the ICHRA plan (step 1230). Upon setting the initial parameters, the system and method can be connected to the employer and member's payroll (step 1240). Finally, the employer's bank information can be linked to the system so that the system and method becomes operational (step 1250). While FIGS. 11 and 12 provide exemplary methods in which the ICHRA plan of the present disclosure may be utilized, it is to be understood that the contemplated system and method for processing healthcare payments through an individual coverage health reimbursement arrangement can be customized and further tailored depending on the employer's and member's needs.

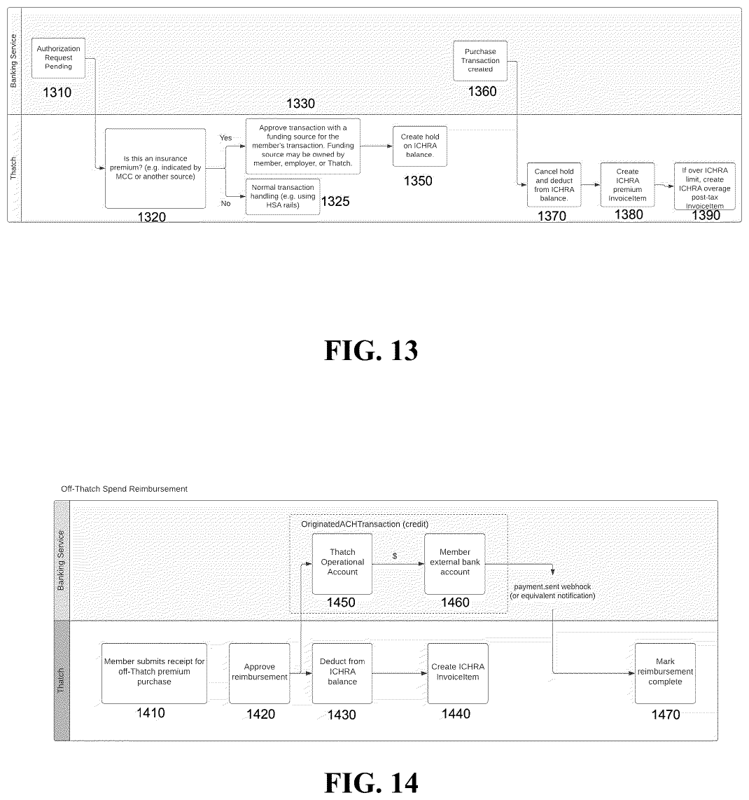

Referring now to FIG. 13, there is shown a process flow diagram illustrating an exemplary method for processing healthcare payments through an individual coverage health reimbursement arrangement according to an embodiment of the present disclosure. Specifically, FIG. 13 identifies how the system treats an authorization request received from a banking-as-a-service provider. When a member uses a payment card issued to the user that is linked to the member checking account to purchase insurance or another qualified medical expense, an authorization request is sent (step 1310). Thereafter, the system will then determine if the purchase in question is related to an allowed insurance premium or a qualified medical expense (step 1320). Preferably, the system may use merchant category codes (“MCC”) to determine whether a payment is for an insurance premium or an approved medical expense. However, it is to be understood that this procedure may become more sophisticated in the future. For example, the system may use transaction descriptors, match specific merchant network identifications or build classifiers to identify eligible expenses. If the transaction is not for an eligible expense or for an insurance premium, it is then directed to be processed through an alternate plan such as an HSA plan (step 1325), as shown in FIGS. 1-9. In certain situations where the system is unable to determine whether a payment is for an insurance premium or an approved medical expense prior to making the payment, a tax status determination may be made after the payment is made based on information subsequently retrieved and/or received from the member, seller, a card network, or another data source.

Upon determining that an expense is related to an insurance premium or an approved medical expense, the system transfers funds from a funding account to the member checking account. Specifically, the funding account can be a system operational account, an employer-owned account, a member-owned account or a combination thereof. The transaction is approved with the funding account serving as the funding source for the member checking account (step 1330). A hold is then subsequently created on the ICHRA balance associated with the member (step 1350). Thereafter, a purchase transaction is created (step 1360). The hold on the ICHRA balance is then canceled and the purchase amount is deducted from the ICHRA balance (step 1370). Following payment to the seller, the amount is recorded into an invoice database and a corresponding invoice is generated (step 1380). Additionally, for any residual amount over the ICHRA balance that remains, an overage invoice is generated for post-tax treatment (step 1390). This overage invoice is then directly linked to the payroll of the employer so it can be deducted from the member's subsequent payroll period, for example.

Referring now to FIG. 14, there is shown a process flow diagram illustrating an exemplary method of issuing reimbursements from an individual coverage health reimbursement arrangement according to an embodiment of the present disclosure. Specifically, FIG. 14 illustrates how the system may reimburse an insurance premium or qualified medical expense for a purchase that was made with a non-system payment instrument, such as an individual's personal funding source. In this case, the member first submits a receipt for the insurance premium purchase or other qualified medical expense (step 1410). Thereafter, the reimbursement is then approved (step 1420). Once the reimbursement is approved, it is deducted from the ICHRA balance (step 1430) and the amount is recorded into an invoice database and a corresponding invoice is generated (step 1440). At the same time, the purchase amount is sent from the funding account, i.e., system operational account (step 1450) to the member's external bank account (step 1460). Finally, the reimbursement for the insurance premium or qualified medical expense is then marked as completed (step 1470).

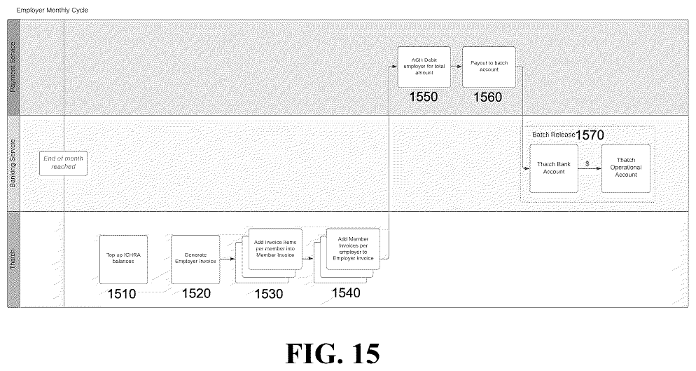

Referring now to FIG. 15, there is shown a process flow diagram illustrating an exemplary method of an employer issuing reimbursements in connection with an individual coverage health reimbursement arrangement according to an embodiment of the present disclosure. Specifically, FIG. 15 illustrates the manner in which the system accounts for reimbursements from employers across its platform. This reimbursement can be customized to a particular time period. For purposes of clarity, the example shown in FIG. 15 refers to a monthly cycle.

At the end of a monthly cycle, the system replenishes the ICHRA balances of the member checking accounts based on the previously determined allotted reimbursement allowance (step 1510). Thereafter, the system generates an employer invoice based on a collective sum of transactions associated with each member of an employer (step 1520). Specifically, the generated invoices for each transaction of each member are combined to generate a combined member invoice (step 1530). Thereafter, the combined member invoices of each of the members of an employer are combined and added to an aggregated employer invoice (step 1540). After the aggregated employer invoice is generated, the system debits the employer for the total amount through an ACH transaction (step 1550). While an ACH transaction is identified, it is to be understood that employers can develop or designate a separate bank account for use with the ICHRA plan at the outset of participation. Thereafter, the amount debited from the employer is transferred to the system batch account (step 1560). Finally, the system then sends the debited amount from the system batch account to the funding account, i.e., system operational account (step 1570), thereby completing the process.

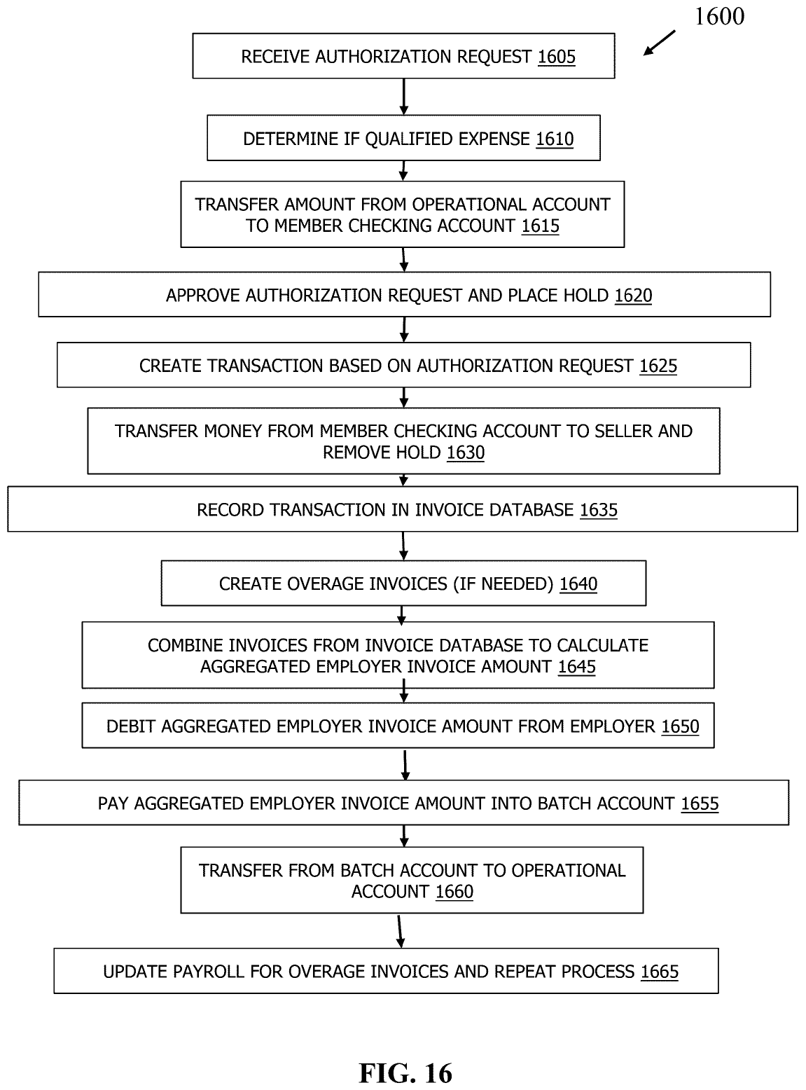

Referring now to FIG. 16, there is shown a process flow diagram of an exemplary configuration of the system for processing healthcare payments according to an embodiment of the present disclosure. Specifically, FIG. 16 illustrates how the funds flow with purchases and reimbursements during a predetermined period of time. The system first receives an authorization request related to a medical expense via a payment card associated with a member checking account (step 1605). Thereafter, the medical expense related to the authorization request is analyzed to determine if the medical expense is a qualified medical expense for the ICHRA plan (step 1610). The amount corresponding to the medical expense is transferred from the funding account, i.e., system operational account to the member checking account (step 1615). The authorization request is then approved and a hold is placed on the member checking account based on the member's reimbursable amount of the medical expense (step 1620). A transaction is then created based on the authorization request (step 1625). Subsequently, the amount is transferred from the member checking account to the seller associated with the transaction, and the hold on the member checking account is removed (step 1630). The amount of the transaction is then recorded into the invoice database, wherein each recorded amount corresponds to a generated invoice (step 1635). It is to be understood that the generated invoice may contain one or more recorded amounts. In connection with step 1635, if needed, an overage invoice is generated if the amount of the transaction exceeds a balance associated with the member checking account (step 1640). Thereafter, the generated invoices from the invoice database are combined to calculate an aggregated employer invoice amount (step 1645). This aggregated employer invoice amount is based on a collective sum of the transactions associated with each member of an employer. Then, the aggregated employer invoice amount is debited from an employer operating account (step 1650). The aggregated employer invoice amount collected from the employer operating account is then paid into the system batch account (step 1655). Thereafter, a transfer of the money is initiated from the system batch account to the funding account, i.e., system operational account (step 1660). Finally, any overage invoices previously generated are dynamically linked to the employer and member's payroll for subsequent processing and the process is then repeated for the next cycle of time (step 1665).

It is to be understood that the cycle of time can be adjusted as well as other aspects of the system for processing healthcare payments through an individual coverage health reimbursement arrangement. For example, the system may be customized such that employers can allot different reimbursement allowances for different classes of members. The system may be further tailored and customized in a number of ways to benefit the employer's needs, the member's needs or to make the system process payments more efficiently.

In accordance with an aspect of the present disclosure, the employer could elect to reimburse the system immediately after a purchase is initiated by a member, rather than at the end of a predetermined cycle of time. Additionally, it is to be understood that alternative means can be used to fund or make payment (rather than a payment card). In accordance with yet another aspect of the present disclosure, the payment could be funded from an account other than the system operational account. That is, it is foreseeable that an employer and its members may enroll in complementary banking services that would facilitate holding a balance on an employer's behalf and funding eligible payments from this deposit, e.g., reserve. For example, this could be a deposit account that is routinely drawn from. In general, the funding account can be the system operational account, an employer-owned account, a member-owned account or a combination thereof based on the needs of the employee and employer. In accordance with another aspect, the employer owned-account and the member-owned account can serve as a funding source for the system operational account.

In accordance with an aspect of the present disclosure, the provided system and method can also be integrated with other forms of funding such as a member-owned bank account to cover spending in excess of a reimbursement allowance. For example, in the absence of employment or a recent termination of an employee's employment, the provided system and method can be integrated with a member-owned bank account to ensure that sufficient funding is always available. Additionally, in the absence of employment or a recent termination of an employee's employment, payments may be funded through a non-member checking account.

As previously discussed, the ICHRA model described above can be used to reimburse insurance premiums and eligible medical expenses even if the transaction did not originate with a payment card issued to the member. It is also foreseeable that the system could contain bank accounts and provide enrolled members with an account number and routing number upon enrollment into the ICHRA plan. Thereafter, members could use these provided account credentials to set up direct payments for monthly insurance premiums. In said scenario, the system could fund the bank account for the insurance premium or eligible medical expense amount immediately before posting an ACH debit.

In sum, the present disclosure includes a method of processing healthcare payments through an individual coverage health reimbursement arrangement. The steps include receiving a transaction related to a qualified medical expense via a payment card linked to a member checking account. An amount corresponding to the transaction is funded from a funding account to the member checking account, wherein the funding account is a system operational account, an employer-owned account or a member-owned account. Then, the amount is transferred from the member checking account to a seller associated with the transaction. The transaction is then recorded into the invoice database, wherein each recorded amount corresponds to a generated invoice. It is to be understood that the generated invoice may contain one or more recorded amounts. The generated invoices in the invoice database are combined to calculate an aggregated employer invoice amount at the end of a predetermined period based on a collective sum of the transactions associated with each member of an employer. The aggregated employer invoice amount is debited from an employer operating account and paid into the system batch account. Thereafter, the amount is transferred from the system batch account to the funding account. In accordance with an aspect, the step of receiving a transaction related to a qualified medical expense, via a payment card, further comprises determining if an amount of the transaction exceeds a predetermined member balance associated with the member checking account. In accordance with another aspect, the step of transferring the amount from the member checking account to a seller associated with the transaction, further comprises placing a hold on the member checking account until the transaction clears. It is to be understood that the step of receiving a transaction related to a qualified medical expense via a payment card may further comprise receiving a plurality of transactions related to qualified medical expenses via a plurality of payment cards associated with a plurality of member checking accounts of an employer. Additionally, the payment card is issued to a member enrolled in the employer ICHRA plan and the payment card is associated with the member checking account. As discussed, the funding account serves as the funding source for the member checking account. It is to be understood that the funding account can be a system operational account, an employer-owned account, a member-owned account or a combination thereof.

In accordance with another aspect, it is to be further understood that a control device in communication with a communications network may perform the method of processing healthcare payments through an individual coverage health reimbursement arrangement. That is, the method may include receiving, by the control device, a transaction related to a qualified medical expense via a payment card linked to a member checking account. The control device may be used to fund an amount corresponding to the transaction from a funding account to the member checking account, wherein the funding account is a system operational account, an employer-owned account or a member-owned account. Thereafter, the control device may transfer the amount from the member checking account to a seller associated with the transaction. The control device may be used to record the amount of the transaction into an invoice database and combine the generated invoices in the invoice database to calculate an aggregated employer invoice amount. Then, the control device can debit the aggregated employer invoice amount from an employer operating account and pay the aggregated employer invoice amount into the system batch account. Finally, the control device may initiate a transfer from the system batch account to the funding account.

In accordance with another aspect of the present disclosure, the system includes a system database, an invoice database, a member database, a payment card, and a software application hosted on a cloud. The system database contains a funding account and a batch account connected to a host server. The invoice database contains a ledger, wherein the invoice database is in communication with the host server. The member database contains an employer operating account and a plurality of member checking accounts associated with each enrolled member of an employer. The member database is also in communication with the host server. The payment card may be a physical debit card or a virtual card issued to each member and associated with a member checking account. Although the software application may be hosted on the system database, the invoice database, or the member database, it is preferably hosted on the cloud. The software application also facilitates communication between the multiple databases discussed above. It is to be understood that one or more of the functional databases discussed above may be used to implement one or more aspects of the methods described herein.

The software application is configured to receive a transaction related to a qualified medical expense via the payment card, fund the transaction from the funding account on the system database to the member checking account, transfer the amount from the member checking account to a seller associated with the transaction, record an amount of the transaction into the invoice database, combine the generated invoices in the invoice database to calculate an aggregated employer invoice amount, and debit the aggregated employer invoice amount from the employer operating account on the member database. The software application is further configured to pay the aggregated employer invoice amount into the batch account on the system database, and initiate a transfer from the batch account to the funding account based on the aggregated employer invoice amount. In accordance with an aspect, the system may further comprise a computer process configured to execute the software application.

In accordance with yet another aspect, the present disclosure is a non-transitory computer program product embodied on a computer readable medium, which, when executed on a computer processor is configured to implement the systems described above.

Software applications as described herein may be implemented over system components and configured to execute various steps in the methods described throughout this disclosure. It should be appreciated that a software application can implement steps in the methods utilizing all of the system components or just portions of the system components. Furthermore, the software applications are described in singular form. It should be appreciated that multiple software applications may interface to perform the described functions, and multiple applications can run on more than one computing devices to implement the methodologies described herein.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or may not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

Furthermore, while this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While the disclosure is described herein, using a limited number of exemplary embodiments, these specific embodiments are not intended to limit the scope of the disclosure as otherwise described and claimed herein. The precise arrangement of various elements and order of the steps of systems and methods described herein are not to be considered limiting. For instance, although the steps of the methods are described with reference to a sequential series of reference signs and progression of the blocks in the figures, the method can be implemented in any order as desired.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A method of processing healthcare payments through an individual coverage health reimbursement arrangement, the method comprising:
receiving a transaction related to a qualified medical expense via a payment card linked to a member checking account;
funding an amount corresponding to the transaction from a funding account to the member checking account;
transferring the amount from the member checking account to a seller associated with the transaction;
recording the amount of the transaction into an invoice database, wherein each recorded amount corresponds to a generated invoice;
combining the generated invoices in the invoice database to calculate an aggregated employer invoice amount at the end of a predetermined period based on a collective sum of the transactions associated with each member of an employer;
debiting the aggregated employer invoice amount from an employer operating account for the predetermined period;
paying the aggregated employer invoice amount into a system batch account; and
initiating a transfer from the system batch account to the funding account.

2. The method of claim 1, wherein the step of receiving a transaction related to a qualified medical expense via a payment card, further comprises determining if an amount of the transaction exceeds a predetermined member balance associated with the member checking account.

3. The method of claim 1, wherein the step of transferring the amount from the member checking account to a seller associated with the transaction, further comprises placing a hold on the member checking account until the transaction clears.

4. The method of claim 1, wherein the step of receiving a transaction related to a qualified medical expense via a payment card, further comprises receiving a plurality of transactions related to qualified medical expenses via a plurality of payment cards associated with a plurality of member checking accounts.

5. The method of claim 1, wherein the payment card is issued to a member associated with a member checking account.

6. The method of claim 1, wherein the generated invoice contains one or more recorded amounts.

7. A method of processing healthcare payments through an individual coverage health reimbursement arrangement for tax savings, the method comprising:
receiving an authorization request related to a medical expense via a payment card associated with a member checking account;
determining whether the medical expense is a qualified medical expense;
transferring an amount corresponding to the medical expense from a funding account to the member checking account;
approving the authorization request and placing a hold on the member checking account based on the amount corresponding to the medical expense;
creating a transaction based on the authorization request;
transferring the amount from the member checking account to a seller associated with the transaction and canceling the hold on the member checking account;
recording the amount of the transaction into an invoice database, wherein each recorded amount corresponds to a generated invoice;
creating an overage invoice if the amount of the transaction exceeds a balance associated with the member checking account;
combining the generated invoices in the invoice database to calculate an aggregated employer invoice amount at the end of a predetermined period based on a collective sum of the transactions associated with each member of an employer;
debiting the aggregated employer invoice amount from an employer operating account for the predetermined period;
paying the aggregated employer invoice amount into a system batch account; and
initiating a transfer from the system batch account to the funding account.

8. A system, comprising:
a system database containing a funding account and a batch account connected to a host server;
an invoice database containing a ledger, wherein the invoice database is in communication with the host server;
a member database containing an employer operating account and a plurality of member checking accounts associated with each member of an employer, the member database in communication with the host server;
a payment card issued to each member of the employer; and
a software application configured to:
a) receive a transaction related to a qualified medical expense via the payment card linked to the member checking account of a member;
b) fund an amount corresponding to the transaction from the funding account on the system database to the member checking account;
c) transfer the amount from the member checking account to a seller associated with the transaction;
d) record the amount of the transaction into the invoice database, wherein each recorded amount corresponds to a generated invoice;
e) combine the generated invoices in the invoice database to calculate an aggregated employer invoice amount at the end of a predetermined period based on a collective sum of the transactions associated with each member of an employer;
f) debit the aggregated employer invoice amount from the employer operating account for the predetermined period;
g) pay the aggregated employer invoice amount into the batch account on the system database; and
h) initiate a transfer from the batch account to the funding account.

9. The system of claim 8, further comprising a computer process configured to execute the software application.

10. A non-transitory computer program product embodied on a computer readable medium, which, when executed on a computer processor is configured to implement system of claim 8.
